(19) United States
(12) Patent Application Publication
(10) Pub. No.: US 2025/0123205 A1
(43) Pub. Date: Apr. 17, 2025

(54) SQUEEZED LIGHT GENERATION WITH A TRIPLY-COUPLED OPTICAL RESONATOR AND SUB-SHOT-NOISE DETECTION

(71) Applicant: RTX BBN Technologies, Inc., Cambridge, MA (US)

(72) Inventors: Moe D. Soltani, Belmont, MA (US); Michael Grace, Watertown, MA (US); Leonardo Matteo Ranzani, Acton, MA (US)

(21) Appl. No.: 18/914,593

(22) Filed: Oct. 14, 2024

Related U.S. Application Data
(60) Provisional application No. 63/544,020, filed on Oct. 13, 2023.

(51) Int. Cl. G01N 21/63

(52) U.S. Cl. CPC G01N 21/636; G01N 2201/06113

(57) ABSTRACT

A squeezed light generator may include a triply-coupled optical resonator having a triplet resonance with a split-resonant frequency spacing Ω, where the triplet resonance receives light at frequencies associated with at least one split-resonant frequency in the triplet resonance and generates squeezed light with at least another split-resonant frequency in the triplet resonance.

### CROSS-REFERENCE TO RELATED APPLICATION

The present application claims the benefit under 35 U.S.C. § 119(e) of U.S. Provisional Application Ser. No. 63/544,020, filed Oct. 13, 2023, entitled SQUEEZED LIGHT GENERATION AND SUB SHOT NOISE DETECTION, naming Moe D. Soltani, Michael Grace, and Leonardo Matteo Ranzani as inventors, which is incorporated herein by reference in the entirety.

### TECHNICAL FIELD

The present disclosure relates generally to squeezed light generation and, more particularly, to squeezed light generation with a triply-coupled optical resonator.

### BACKGROUND

Laser light has an inherent shot noise, which sets a limit for sensitive detection below this laser shot noise. For example, optical homodyne detection is a common technique providing detection down to this shot noise limit, but does not allow for detection below this shot noise limit. There is therefore a need to develop systems and methods providing sensitive optical detection.

### SUMMARY

In some embodiments, the techniques described herein relate to a squeezed light generator including a triply-coupled optical resonator having a triplet resonance with a split-resonant frequency spacing, wherein the triplet resonance includes a center split-resonant frequency and two sideband split-resonant frequencies; a laser source configured to generate light with the center split-resonant frequency; and an optical modulator driven by the split-resonant frequency spacing, wherein the optical modulator is configured to receive the light from the laser source and generate pump light with the two sideband split-resonant frequencies, wherein the triply-coupled optical resonator receives the pump light and generates squeezed light at the center split-resonant frequency.

In some embodiments, the techniques described herein relate to a squeezed light generator, further including a filter to pass the squeezed light at the center split-resonant frequency and reject residual light at the two sideband split-resonant frequencies.

In some embodiments, the techniques described herein relate to a squeezed light generator, wherein the filter has an insertion loss equal to or less than 1 dB.

In some embodiments, the techniques described herein relate to a squeezed light generator, wherein the optical modulator is configured to at least partially suppress the center split-resonant frequency.

In some embodiments, the techniques described herein relate to a squeezed light generator, wherein a squeezing ratio of the squeezed light is provided by, where is an intensity transmission of the center split-resonant frequency within the triply-coupled optical resonator and is the squeezing ratio generated in the triply-coupled optical resonator when is 1.

In some embodiments, the techniques described herein relate to a squeezed light generator, wherein the center split-resonant frequency of the triply-coupled optical resonator has the intensity transmission of more than 90% to preserve the squeezing ratio greater than 10 dB.

In some embodiments, the techniques described herein relate to a squeezed light generator, further including one or more filters between the optical modulator and the triply-coupled optical resonator configured to reject the center split-resonant frequency from the pump light.

In some embodiments, the techniques described herein relate to a squeezed light generator, wherein the triply-coupled optical resonator includes three triply-coupled traveling-wave resonators.

In some embodiments, the techniques described herein relate to a sensor including a triply-coupled optical resonator having a triplet resonance with a split-resonant frequency spacing, wherein the triplet resonance includes a center split-resonant frequency and two sideband split-resonant frequencies; a laser source configured to generate light with the center split-resonant frequency; an optical modulator driven by the split-resonant frequency spacing, wherein the optical modulator is configured to receive the light from the laser source and generate pump light with the two sideband split-resonant frequencies, wherein the triply-coupled optical resonator receives the pump light and generates squeezed light at the center split-resonant frequency; and a homodyne detector configured to receive the squeezed light and signal light at the center split-resonant frequency, wherein the homodyne detector generates a detection signal associated with the signal light.

In some embodiments, the techniques described herein relate to a sensor, wherein the signal light is generated by tapping a portion of the light from the laser source.

In some embodiments, the techniques described herein relate to a sensor, further including a filter to receive the light from the optical modulator, wherein the filter provides the pump light with the two sideband split-resonant frequencies to the triply-coupled optical resonator and provides light with the center split-resonant frequency as the signal light.

In some embodiments, the techniques described herein relate to a sensor, further including one or more filters between the triply-coupled optical resonator and the homodyne detector to pass the squeezed light at the center split-resonant frequency and reject residual light at the two sideband split-resonant frequencies.

In some embodiments, the techniques described herein relate to a sensor, wherein the triply-coupled optical resonator includes one more phase shifters to tune the split-resonant frequency spacing of the triplet resonance.

In some embodiments, the techniques described herein relate to a sensor, further including control circuitry to lock the triply-coupled optical resonator with the pump light.

In some embodiments, the techniques described herein relate to a sensor, wherein the optical modulator is further driven by a monitoring frequency to generate monitoring frequency peaks surrounding the two sideband split-resonant frequencies of the pump light, wherein the control circuitry include Pound-Driver-Hall control circuitry.

In some embodiments, the techniques described herein relate to a sensor, wherein the triply-coupled optical resonator includes three triply-coupled traveling-wave resonators.

In some embodiments, the techniques described herein relate to a sensor, wherein the optical modulator is configured to at least partially suppress the center split-resonant frequency.

In some embodiments, the techniques described herein relate to a sensor, further including one or more filters between the optical modulator and the triply-coupled optical resonator configured to reject the center split-resonant frequency from the pump light.

In some embodiments, the techniques described herein relate to a sensor, wherein a squeezing ratio of the squeezed light is provided by, where is an intensity transmission of the center split-resonant frequency within the triply-coupled optical resonator and is the squeezing ratio generated in the triply-coupled optical resonator when is 1.

In some embodiments, the techniques described herein relate to a method including generating light with an optical frequency corresponding to a center split-resonant frequency of a triply-coupled optical resonator, wherein the triply-coupled optical resonator provides triplet resonance with a split-resonant frequency spacing, wherein the triplet resonance includes the center split-resonant frequency and two sideband split-resonant frequencies; generating, with an optical modulator, pump light with the two sideband split-resonant frequencies; and generating, with the triply-coupled optical resonator, squeezed light with the center split-resonant frequency based on the pump light.

In some embodiments, the techniques described herein relate to a squeezed light generator including a triply-coupled optical resonator having a triplet resonance with a split-resonant frequency spacing, wherein the triplet resonance includes a center split-resonant frequency and two sideband split-resonant frequencies; and a laser source configured to generate pump light with the center split-resonant frequency, wherein the triply-coupled optical resonator receives the pump light with the center split-resonant frequency and generates squeezed light at the two sideband split-resonant frequencies.

In some embodiments, the techniques described herein relate to a squeezed light generator, further including a filter to pass the squeezed light at the two sideband split-resonant frequencies and reject residual light at the center split-resonant frequency.

In some embodiments, the techniques described herein relate to a squeezed light generator, wherein the filter has an insertion loss equal to or less than 1 dB.

In some embodiments, the techniques described herein relate to a squeezed light generator, wherein the triply-coupled optical resonator includes three triply-coupled traveling-wave resonators.

In some embodiments, the techniques described herein relate to a squeezed light generator, wherein a squeezing ratio of the squeezed light is provided by, where is an intensity transmission of the two sideband split-resonant frequencies within the triply-coupled optical resonator and is the squeezing ratio generated in the triply-coupled optical resonator when is 1.

In some embodiments, the techniques described herein relate to a sensor including a triply-coupled optical resonator having a triplet resonance with a split-resonant frequency spacing, wherein the triplet resonance includes a center split-resonant frequency and two sideband split-resonant frequencies; a laser source configured to generate pump light with the center split-resonant frequency, wherein the triply-coupled optical resonator receives the pump light and generates squeezed light at the two sideband split-resonant frequencies; an optical modulator driven by the split-resonant frequency spacing, wherein the optical modulator is configured to receive a portion of the pump light from the laser source and generate signal light with the two sideband split-resonant frequencies; and a homodyne detector configured to receive the squeezed light and the signal light at the two sideband split-resonant frequencies, wherein the homodyne detector generates a detection signal associated with the signal light.

In some embodiments, the techniques described herein relate to a sensor, further including a filter between the triply-coupled optical resonator and the homodyne detector to pass the squeezed light at the two sideband split-resonant frequencies and reject residual light at the center split-resonant frequency.

In some embodiments, the techniques described herein relate to a sensor, wherein the filter has an insertion loss equal to or less than 1 dB.

In some embodiments, the techniques described herein relate to a sensor, wherein the optical modulator is configured to at least partially suppress the center split-resonant frequency.

In some embodiments, the techniques described herein relate to a sensor, wherein a squeezing ratio of the squeezed light is provided by, where is an intensity transmission of the two sideband split-resonant frequencies within the triply-coupled optical resonator and is the squeezing ratio generated in the triply-coupled optical resonator when is 1.

In some embodiments, the techniques described herein relate to a sensor, further including a filter to receive light from the optical modulator, wherein the filter at least partially suppresses the center split-resonant frequency from the light.

In some embodiments, the techniques described herein relate to a sensor, wherein the triply-coupled optical resonator includes one more phase shifters to tune the split-resonant frequency spacing of the triplet resonance.

In some embodiments, the techniques described herein relate to a sensor, further including control circuitry to lock the triply-coupled optical resonator with the pump light.

In some embodiments, the techniques described herein relate to a sensor, further including an additional optical modulator driven by a monitoring frequency to generate monitoring frequency peaks surrounding the center split-resonant frequency of the pump light, wherein the control circuitry include Pound-Driver-Hall control circuitry.

In some embodiments, the techniques described herein relate to a sensor, wherein the triply-coupled optical resonator includes three triply-coupled traveling-wave resonators.

In some embodiments, the techniques described herein relate to a sensor, further including one or more filters between the optical modulator and the triply-coupled optical resonator configured to reject the center split-resonant frequency from the pump light.

In some embodiments, the techniques described herein relate to a method including generating pump light with an optical frequency corresponding to a center split-resonant frequency of a triply-coupled optical resonator, wherein the triply-coupled optical resonator provides triplet resonance with a split-resonant frequency spacing, wherein the triplet resonance includes the center split-resonant frequency and two sideband split-resonant frequencies; and generating, using the triply-coupled optical resonator, squeezed light with the two sideband split-resonant frequencies based on the pump light.

In some embodiments, the techniques described herein relate to a method, further including isolating the squeezed light with the two sideband split-resonant frequencies with a filter.

In some embodiments, the techniques described herein relate to a method, wherein the filter has an insertion loss equal to or less than 1 dB.

In some embodiments, the techniques described herein relate to a method, wherein the triply-coupled optical resonator includes three triply-coupled traveling-wave resonators.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures.

FIG. 1 illustrates a block diagram depicting a system providing squeezed light, in accordance with one or more embodiments of the present disclosure.

FIG. 2 illustrates two techniques for generating squeezed light using a non-linear material with third-order optical non-linearity, in accordance with one or more embodiments of the present disclosure.

FIG. 3A illustrates a conceptual schematic of a triply-coupled optical resonator with three individual resonators formed as ring resonators, in accordance with one or more embodiments of the present disclosure.

FIG. 3B illustrates a conceptual schematic of a triply-coupled optical resonator with three individual resonators formed as racetrack resonators, in accordance with one or more embodiments of the present disclosure.

FIG. 3C illustrates coupling between two individual resonators having the design shown in FIG. 3B, in accordance with one or more embodiments of the present disclosure.

FIG. 4 illustrates a plot of split-resonant frequencies surrounding three exemplary longitudinal modes of a triply-coupled optical resonator, in accordance with one or more embodiments of the present disclosure.

FIG. 5A illustrates a first simplified schematic of a system providing squeezed light at a center split-resonant frequency of a triplet resonance supported by a triply-coupled optical resonator, in accordance with one or more embodiments of the present disclosure.

FIG. 5B illustrates a first plot of transmission as a function of optical frequency through a triply-coupled optical resonator associated with FIG. 5A, in accordance with one or more embodiments of the present disclosure.

FIG. 5C illustrates a second plot of transmission as a function of optical frequency through a triply-coupled optical resonator associated with FIG. 5A, in accordance with one or more embodiments of the present disclosure.

FIG. 5D illustrates a second simplified schematic of a system providing squeezed light at a center split-resonant frequency of a triplet of split-resonant frequencies supported by a triply-coupled optical resonator, in accordance with one or more embodiments of the present disclosure.

FIG. 6A illustrates a simplified schematic of a system providing squeezed light at a center split-resonant frequency of a triplet of split-resonant frequencies supported by a triply-coupled optical resonator and further providing control circuitry to lock the pump light and the triply-coupled optical resonator, in accordance with one or more embodiments of the present disclosure.

FIG. 6B illustrates a simplified schematic of a system providing squeezed light at a center split-resonant frequency of a triplet of split-resonant frequencies supported by a triply-coupled optical resonator and further providing control circuitry to lock the pump light and the triply-coupled optical resonator using monitoring frequency peaks, in accordance with one or more embodiments of the present disclosure.

FIG. 6C illustrates a simplified schematic of a portion of FIG. 7A with additional detail of the control circuitry, in accordance with one or more embodiments of the present disclosure.

FIG. 6D illustrates a plot of a control signal at the Y position of FIG. 6C, in accordance with one or more embodiments of the present disclosure.

FIG. 6E illustrates a plot of a control signal at the Z position of FIG. 6C, in accordance with one or more embodiments of the present disclosure.

FIG. 7A illustrates a simplified schematic of a system providing squeezed light at sideband split-resonant frequencies of a triplet of split-resonant frequencies supported by a triply-coupled optical resonator and further providing control circuitry to lock the pump light and the triply-coupled optical resonator using monitoring frequency peaks, in accordance with one or more embodiments of the present disclosure.

FIG. 7B illustrates a plot of transmission as a function of optical frequency through a triply-coupled optical resonator associated with FIG. 7A, in accordance with one or more embodiments of the present disclosure.

FIG. 8 is a flow diagram illustrating steps performed in a method for generating squeezed light at a center split-resonant frequency of a triply-coupled optical resonator, in accordance with one or more embodiments of the present disclosure.

FIG. 9 is a flow diagram illustrating steps performed in a method for generating squeezed light at a center split-resonant frequency of a triply-coupled optical resonator, in accordance with one or more embodiments of the present disclosure.

### DETAILED DESCRIPTION

Reference will now be made in detail to the subject matter disclosed, which is illustrated in the accompanying drawings.

Before explaining one or more embodiments of the disclosure in detail, it is to be understood the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one,” “one or more,” or “at least one,” and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination of or sub-combination of two or more such features, along with any other features which may not necessarily be expressly described or inherently present in the instant disclosure.

Embodiments of the present disclosure are directed to systems and methods providing squeezed light using a triply-coupled optical resonator. This squeezed light may be suitable for, but is not limited to, sensitive optical detection below a laser shot noise limit of light used to generate the squeezed light.

The generation of squeezed light using existing techniques is generally described in XX; all of which are incorporated herein by reference in their entireties. In some embodiments of the present disclosure, squeezed light is generated in a triply-coupled optical resonator in a third-order nonlinear optical medium.

Additional embodiments of the present disclosure incorporate a heterodyne detector for sensitive measurements of the properties of the squeezed light and/or sensitive detection below a laser shot noise limit of light used to generate the squeezed light. Additional embodiments of the present disclosure incorporate filters and/or feedback loops to ensure stable and efficient squeezed light generation.

In some embodiments, one or more components for generating squeezed light and/or sensing based on the squeezed light are integrated into a photonic integrated circuit (PIC) package. For example, the triply-coupled optical resonator and/or any combination of a pump source, a homodyne detector, filters, or feedback components may be integrated into one or more PIC packages.

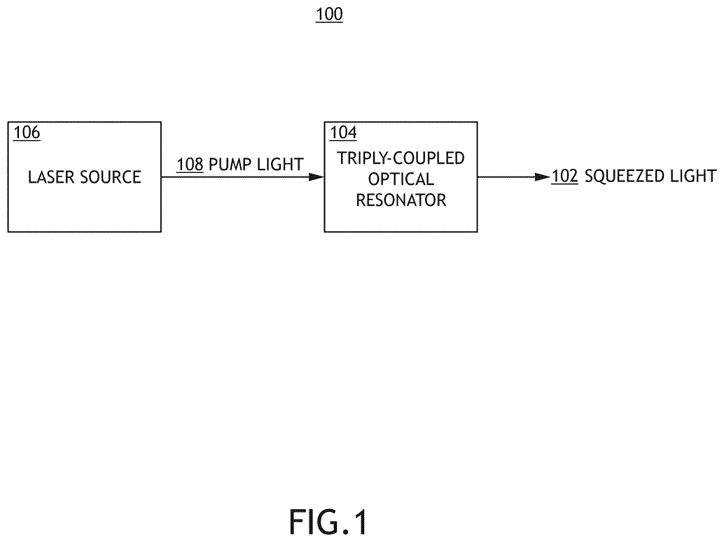

FIGS. 1-9 illustrate systems and methods providing squeezed light using a triply-coupled optical resonator, in accordance with one or more embodiments of the present disclosure.

FIG. 1 illustrates a block diagram depicting a system 100 providing squeezed light 102, in accordance with one or more embodiments of the present disclosure.

In some embodiments, the system 100 includes a triply-coupled optical resonator 104 having three split-resonant frequencies separated by a split-resonant frequency spacing Ω and a laser source 106 to generate pump light 108 having at least one of the three split-resonant frequencies. In this configuration, the triply-coupled optical resonator 104 may receive the pump light 108 at one or more of the split-resonant frequencies and generate squeezed light 102 with at least one other of the split-resonant frequencies based on third-order optical non-linearities such as, but not limited to, four-wave mixing.

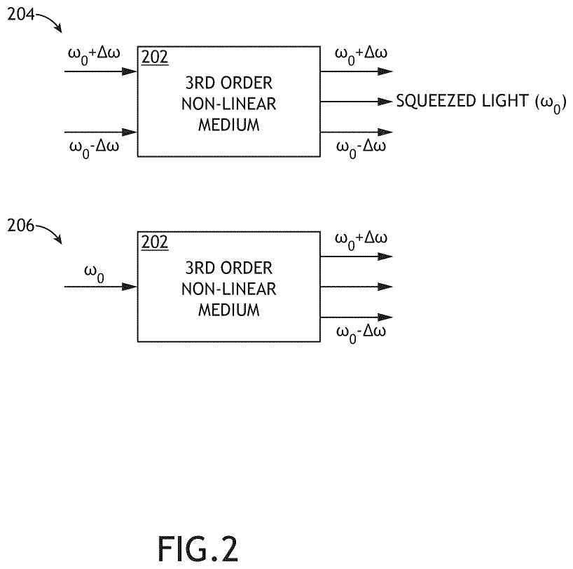

FIG. 2 illustrates two techniques for generating squeezed light 102 using a non-linear material 202 with third-order optical non-linearity, in accordance with one or more embodiments of the present disclosure. In panel 204, the non-linear material 202 receives pump light 108 having frequencies ω₀−Δω and ω₀+Δω and generates squeezed light 102 at a frequency ω. In panel 206, the non-linear material 202 receives pump light 108 having a frequency ω and generates squeezed light 102 having frequencies ω₀−Δω and ω₀+Δω.

It is contemplated herein that a triply-coupled optical resonator 104 formed from a non-linear material 202 may provide a compact, robust, and flexible platform for generating squeezed light 102. In particular, the triply-coupled optical resonator 104 may be designed to support a single triplet of split-resonant frequencies ω₀−Δ, ω₀, and ω₀+Δω and may thus provide efficient generation of squeezed light 102 using either of the techniques depicted in FIG. 2.

Additionally, the triply-coupled optical resonator 104 as well as various additional components (e.g., a laser source 106, detectors, or other components) may formed as a photonic integrated circuit (PIC), which may provide a compact form factor. Further, the triply-coupled optical resonator 104 and other components integrated into a PIC may be fabricated using any suitable materials including, but not limited to, semiconductors, compound semiconductors, dielectric materials, or non-linear materials (e.g., non-linear crystals). As one non-limiting illustration, the triply-coupled optical resonator 104 may be formed from silicon nitride (SiN) on a base of silicon dioxide (SiO₂).

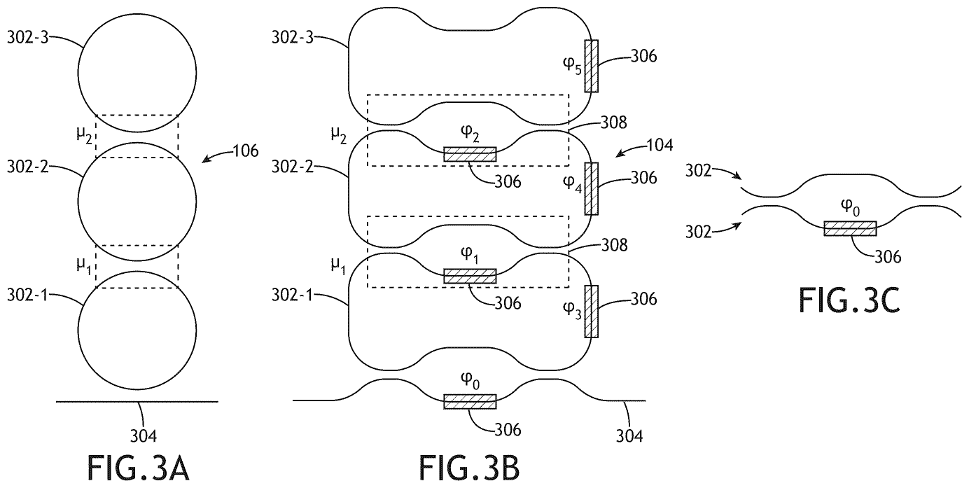

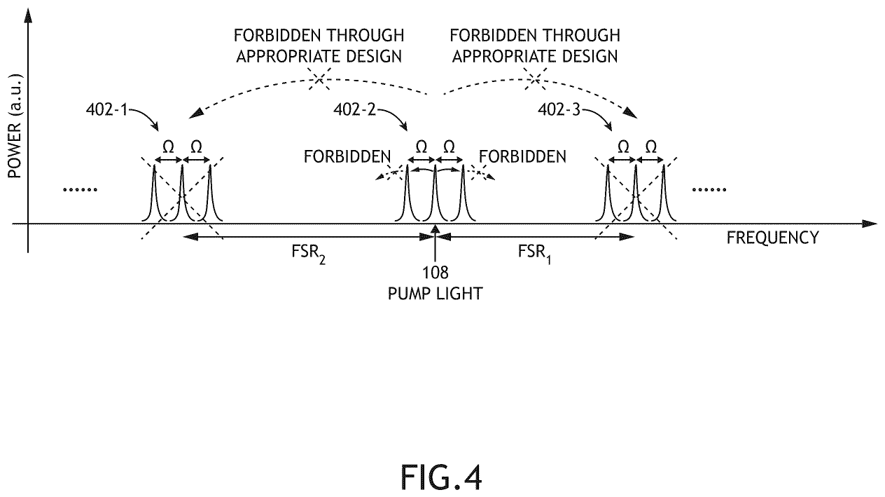

Referring now to FIGS. 3A-4, the triply-coupled optical resonator 104 is described in greater detail, in accordance with one or more embodiments of the present disclosure.

The triply-coupled optical resonator 104 may have any design suitable for generating squeezed light 102. The triply-coupled optical resonator 104 may include three coupled individual resonators 302 of any type arranged to support three coupled split-resonant frequencies separated by a split-frequency spacing, where this split-frequency spacing is controlled by intracavity coupling between the individual resonators 302. For example, the split-resonant frequencies are associated with split resonant modes formed by intracavity coupling of these individual resonators 302.

The individual resonators 302 may any type of resonating element (e.g., cavity) suitable for supporting split-resonant frequencies associated with intracavity coupling. In some embodiments, the individual resonators 302 are traveling-wave resonators such as, but not limited to, ring resonators or racetrack resonators. In some embodiments, the individual resonators 302 are standing wave resonators such as, but not limited to Fabry-Perot resonators.

FIG. 3A illustrates a conceptual schematic of a triply-coupled optical resonator 104 with three individual resonators 302 formed as ring resonators, in accordance with one or more embodiments of the present disclosure. In particular, FIG. 3A depicts a first individual resonator 302-1 coupled to a waveguide 304, a second individual resonator 302-2 coupled to the first individual resonator 302-1 (e.g., with a coupling coefficient μ₁), and a third individual resonator 302-3 coupled to the second individual resonator 302-2 (e.g., with a coupling coefficient μ₂).

FIG. 3B illustrates a conceptual schematic of a triply-coupled optical resonator 104 with three individual resonators 302 formed as racetrack resonators, in accordance with one or more embodiments of the present disclosure. In a manner similar to FIG. 3A, FIG. 3B depicts a first individual resonator 302-1 coupled to the waveguide 304, a second individual resonator 302-2 coupled to the first individual resonator 302-1 (e.g., with a coupling coefficient μ₁), and a third individual resonator 302-3 coupled to the second individual resonator 302-2 (e.g., with a coupling coefficient μ₂).

The individual resonators 302 may have the same length (e.g., perimeter length) or may have different lengths so long as they support at least one common longitudinal mode. For example, an individual resonator 302 may generally support a series of longitudinal modes at optical frequencies w separated by a FSR, which is inversely related to its length. More generally, the FSR is related to a round-trip time of light through the resonator and is thus dependent on an optical path length of light in the individual resonator 302. As a result, the FSR is related to the group index or group velocity such that the FSR (and thus the frequency separation between any two particular frequency peaks) may be frequency-dependent in a dispersive medium. Taken together, coupling between two individual resonators 302 may occur for light with optical frequencies corresponding to any common longitudinal modes. The depictions in FIGS. 3A and 3B in which the individual resonators 302 have equal lengths is thus merely illustrative and is not limiting on the scope of the present disclosure.

In some embodiments, the triply-coupled optical resonator 104 includes one or more phase shifters 306 to control the phase of light throughout the individual resonators 302 (or the waveguide 304), which may be used to control the intracavity coupling between the individual resonators 302. For example, FIG. 3B depicts an induced phase ϕ for each of six illustrated phase shifters 306.

FIG. 3C illustrates coupling between two individual resonators 302 having the design shown in FIG. 3B, in accordance with one or more embodiments of the present disclosure. For example, FIG. 3C illustrations coupling regions shown the boxes 308 in FIG. 3B. In this configuration, the coupling coefficients μ_{1,2} may be related to phases φ_{1,2} induced by associated phase shifters 306 by the following expression:

$${μ}_{1 , 2} = FSR [ 1 - 2 k cos ( \frac{{ϕ}_{1 , 2}}{2} ) ] , \qquad ( 1 )$$

where FSR is the free spectral range of the individual resonators 302 and k is a coupling coefficient.

The triply-coupled optical resonator 104 may thus generate split-resonant frequencies of around an input optical frequency ω₀ as follows:

$${ω}^{m} = {ω}_{0} + m \sqrt{{μ}_{1}^{2} + {μ}_{2}^{2}} , \qquad ( 2 )$$

$$m = - 1 , 0 , + 1 , \qquad ( 3 )$$

where m is a resonant mode number, μ₁ is a coupling coefficient between a first individual resonator 302-1 and a second individual resonator 302-2, and μ₂ is a coupling coefficient between a second individual resonator 302-2 and a third individual resonator 302-3. In this way, the triply-coupled individual resonators 302 may provide a triplet of split-resonant frequencies that are each separated by a split-frequency spacing

$$Ω = {ω}^{m + 1} - {ω}^{m} = \sqrt{{μ}_{1}^{2} + {μ}_{2}^{2}} .$$

It is noted that the number and locations of the phase shifters 306 in FIGS. 3B-3C are merely illustrative and not limiting. In general, the triply-coupled optical resonator 104 may include any number of phase shifters 306 (or zero phase shifters 306) at any locations suitable for providing desired coupling between the triply-coupled optical resonator 104. Further, a coupling interface between the individual resonators 302 may have any design including, but not limited to, Mach-Zehnder interferometer.

Further, these split-resonant frequencies may potentially surround any of the longitudinal modes separated by the FSR of any of the individual resonators 302. However, in some embodiments, light generation is only supported with high efficiency for a single triplet of split-resonant frequencies.

FIG. 4 illustrates a plot of split-resonant frequencies surrounding three exemplary longitudinal modes of a triply-coupled optical resonator 104, in accordance with one or more embodiments of the present disclosure. For example, FIG. 4 depicts three sets of potential split-resonant frequencies (e.g., sets of triplet split-resonant frequencies labeled as 402-1, 402-2, and 402-3), where the sets of split-resonant frequencies are separated by the FSR, and where the individual split-resonant frequencies within each set are separated by a split-frequency spacing Ω. In FIG. 4, the split-frequency spacing Ω between split-resonant frequencies in each set is constant, even if the value of the FSR and thus the separation between sets varies (e.g., due to dispersion). For example, FIG. 4 illustrates a first FSR value (FSR₁) between the set of split-resonant frequencies 402-2 and the set of split-resonant frequencies 402-3, along with a second FSR value (FSR₂) between the set of split-resonant frequencies 402-2 and the set of split-resonant frequencies 402-1.

In some embodiments, the triply-coupled optical resonator 104 is designed to provide that only a single set of split-resonant frequencies around a single longitudinal mode is supported. As an illustration, FIG. 4 illustrates how only the set of split-resonant frequencies 402-2 is supported, whereas the sets of split-resonant frequencies 402-1,402-3 are forbidden (e.g., not phase matched such that energy conversion into such frequencies is weak or non-existent).

Any properties of the triply-coupled optical resonator 104 (or the constituent individual resonators 302) may be selected to provide that phase-matching conditions are only satisfied for a single set of split-resonant frequencies around a single longitudinal mode. For example, phase-matching conditions in the triply-coupled optical resonator 104 may be governed by properties such as, but not limited to, the lengths of any of the individual resonators 302 (related to the FSR values of the individual resonators 302), shapes of the individual resonators 302, or material of the individual resonators 302 (related to nonlinearities that generate light at the split-resonant frequencies and/or dispersion in the individual resonators 302), any combination of which may be controlled to limit phase matching to a single set of split-resonant frequencies around a single longitudinal mode.

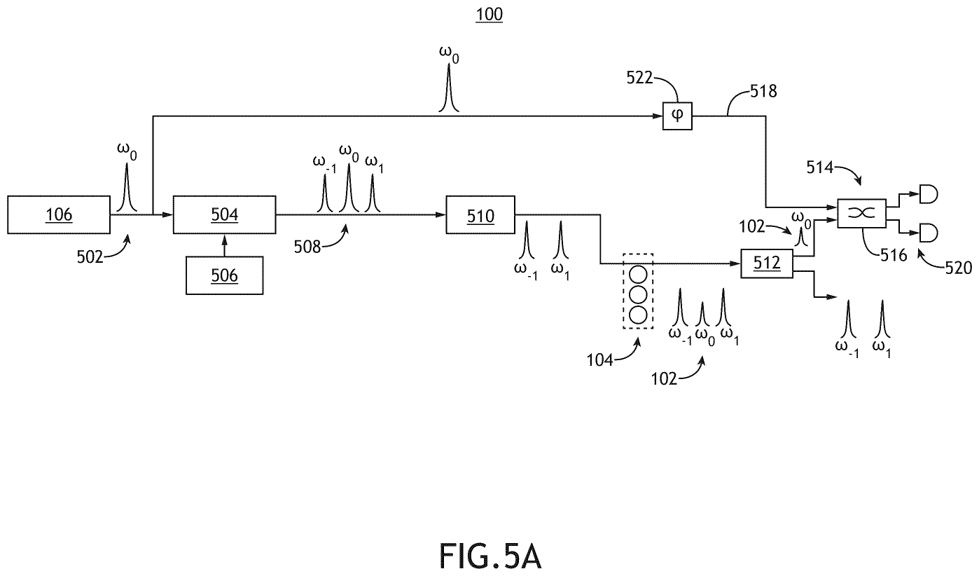

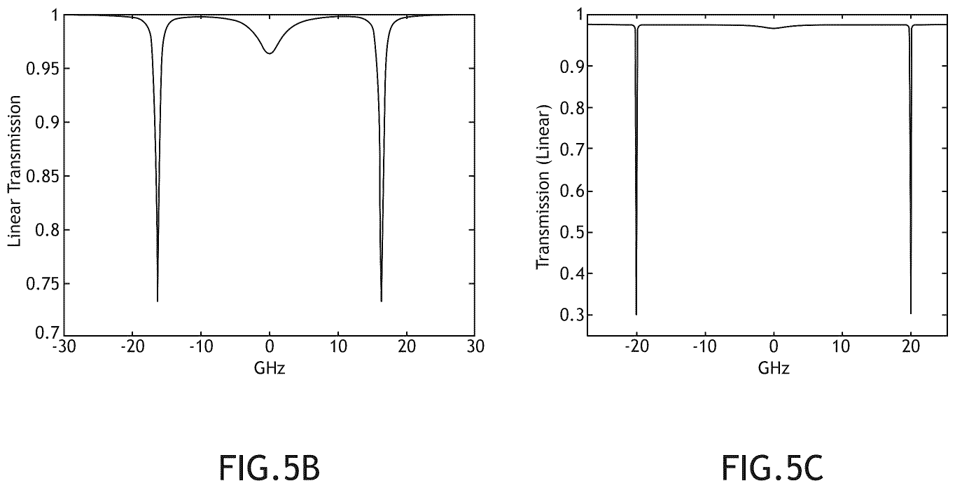

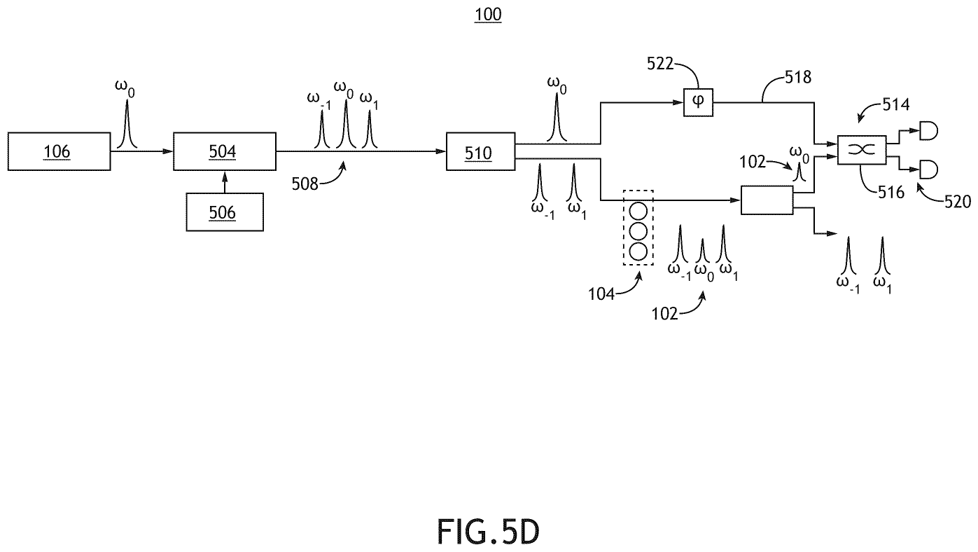

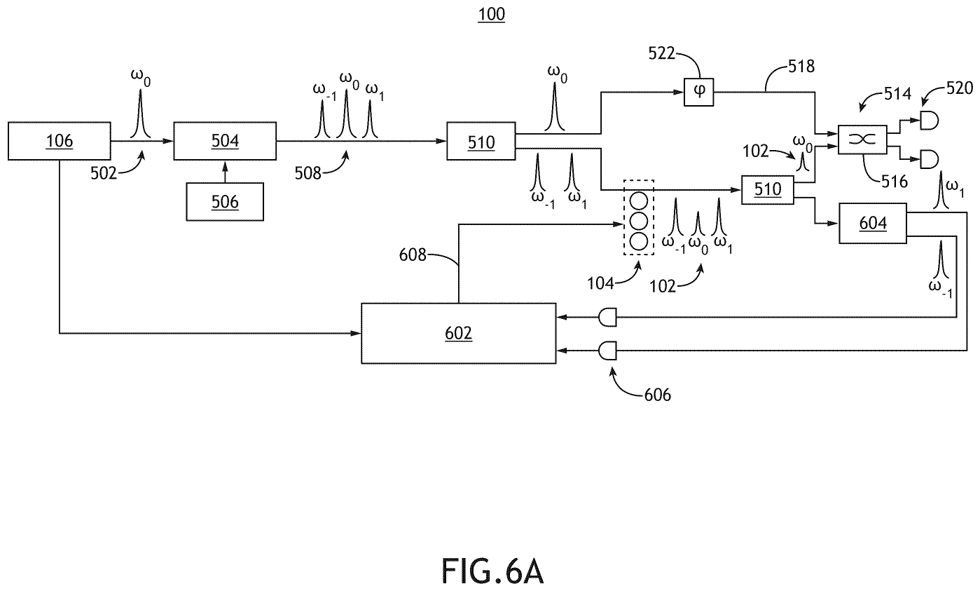

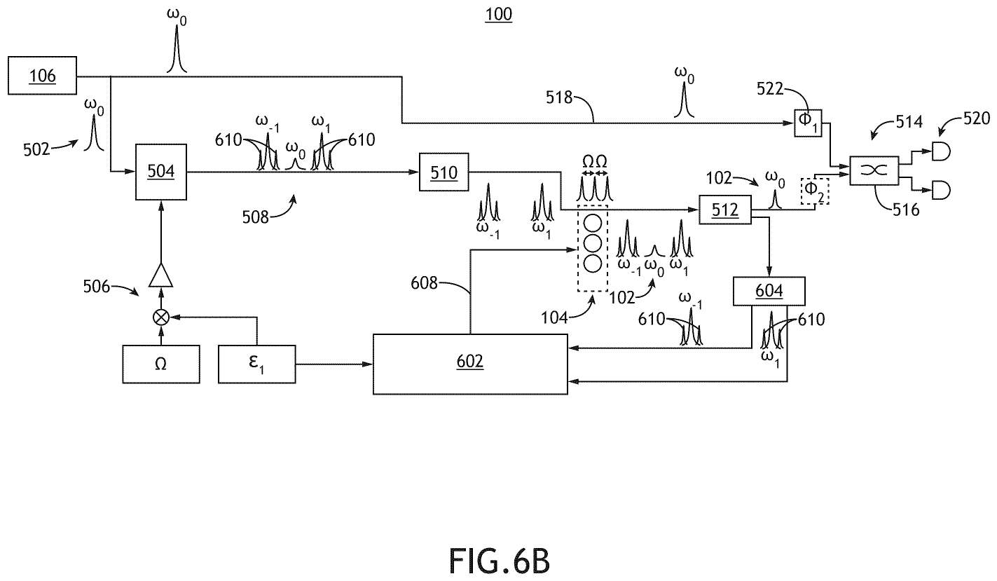

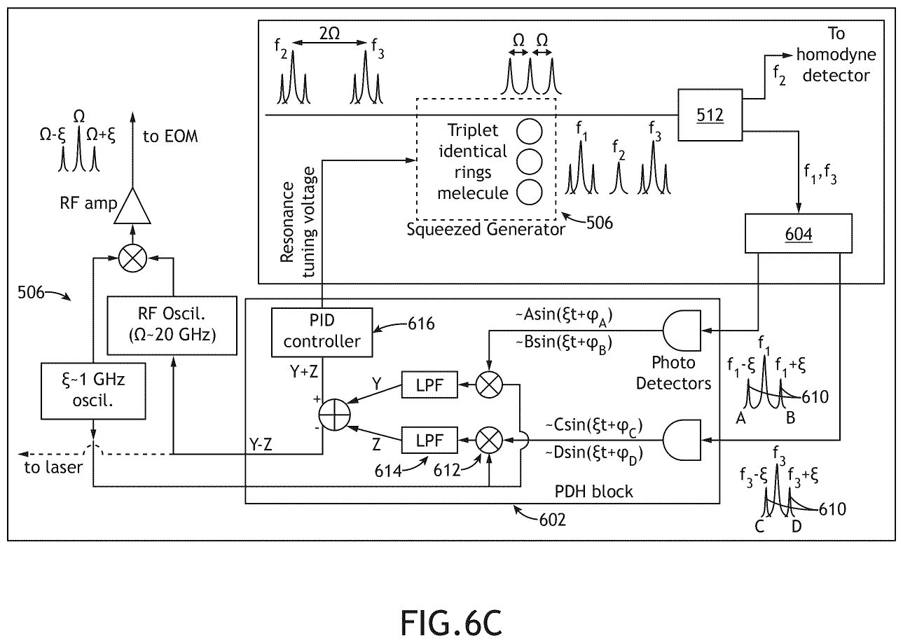

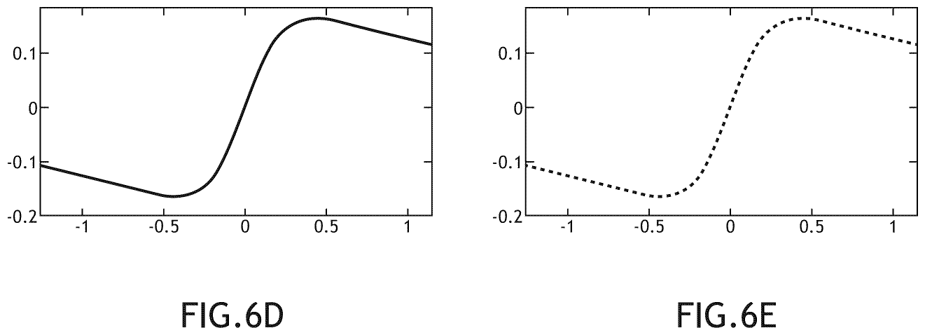

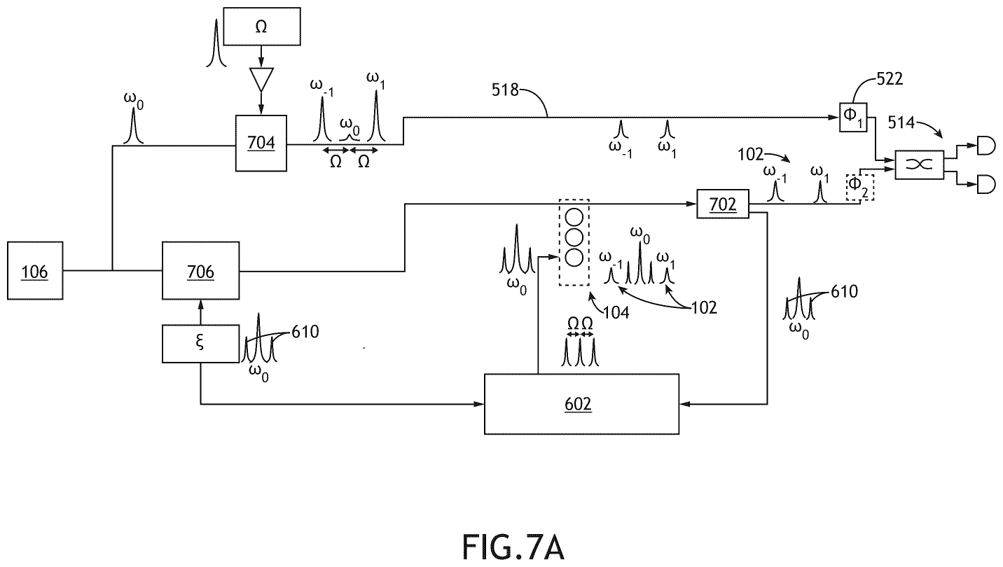

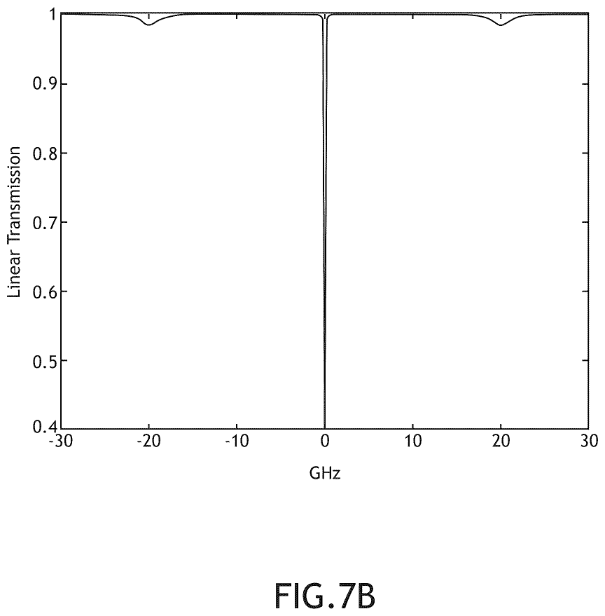

Referring now to FIGS. 5A-7B, the generation of squeezed light 102 with a triply-coupled optical resonator 104 is described, in accordance with one or more embodiments of the present disclosure. In particular, FIGS. 5A-6E depict the generation of squeezed light 102 using the technique depicted in panel 204 of FIG. 2 and FIGS. 7A-7B depicts the generation of squeezed light 102 using the technique depicted in panel 206 of FIG. 2.

FIG. 5A illustrates a first simplified schematic of a system 100 providing squeezed light 102 at a center split-resonant frequency ω₀ of a triplet resonance supported by a triply-coupled optical resonator 104, in accordance with one or more embodiments of the present disclosure.

In some embodiments, the system 100 generates squeezed light 102 at a center split-resonant frequency ω₀ of a triplet resonance supported by a triply-coupled optical resonator 104 by providing seed light at the center split-resonant frequency ω₀, generating sidebands at sideband split-resonant frequencies ω₀−Δω and ω₀+Δω (referred to herein as ω₋₁ and ω₁), filtering out the center split-resonant frequency wo, and providing the sideband split-resonant frequencies ω₋₁ and ω₁ to the triply-coupled optical resonator 104 as pump light 108. The triply-coupled optical resonator 104 may then generate squeezed light 102 with the center split-resonant frequency ω₀ based on non-linear processes such as, but not limited to, four-wave mixing.

In FIG. 5A the system 100 includes a laser source 106 to generate light 502 with the center split-resonant frequency ω₀ and further includes an optical modulator 504 (e.g., an electro-optic modulator, or the like) driven by a radio-frequency (RF) source 506 tuned to the split-resonant frequency spacing Ω of the triply-coupled optical resonator 104 to provide light 508 including at least the two sideband split-resonant frequencies ω₋₁ and ω₁. The system 100 may utilize any split-resonant frequency spacing. In some embodiments, the split-resonant frequency spacing Ω is on the order of 10−15 GHz.

Various techniques may be utilized to minimize or eliminate the center split-resonant frequency ω₀ from the pump light 108 sent to the triply-coupled optical resonator 104. In some embodiments, the system 100 includes at least one filter 510 to at least partially suppress the center split-resonant frequency ω₀ from the pump light 108 provided to the triply-coupled optical resonator 104. In some embodiments, the optical modulator 504 is configured to efficiently convert light from the center split-resonant frequency ω₀ to the two sideband split-resonant frequencies ω₋₁ and ω₁. In this way, the optical modulator 504 may at least partially suppress the center split-resonant frequency wo from the pump light 108 provided to the triply-coupled optical resonator 104.

Further, it is contemplated herein that a squeezing ratio associated with the squeezed light 102 may depend on an intensity transmission (or loss) at frequencies associated with the squeezed light 102 (e.g., the center split-resonant frequency here) within the triply-coupled optical resonator 104. For example, a squeezing ratio S of the squeezed light may be by

$$S ( dB ) = - 10 {log}_{10} ( 1 - η + η {V}_{0} ) , \qquad ( 1 )$$

where η is an intensity transmission of the center split-resonant frequency within the triply-coupled optical resonator 104 and V₀ is a squeezing ratio generated in the triply-coupled optical resonator 104 when η is 1. In this way, the intensity transmission of the frequencies of the squeezed light 102 (e.g., the center split-resonant frequency here) may be engineered to be less than a certain amount to ensure that the squeezing ratio is greater than a certain amount. As an illustration, the intensity transmission of the frequencies of the squeezed light 102 (e.g., the center split-resonant frequency here) may be engineered to be less 90% to ensure that (e.g., preserve) the squeezing ratio is greater than 10 dB. As another illustration, the intensity transmission of the frequencies of the squeezed light 102 (e.g., the center split-resonant frequency here) may be engineered to be less 99% to ensure that (e.g., preserve) the squeezing ratio is greater than 20 dB.

Additionally, the intensity transmission of the pump light 108 may be designed to be sufficiently low (ideally close to 0) to provide large intensity build-up of the pump light 108 in the triply-coupled optical resonator 104 and thus provide strong nonlinear enhancement for efficient generation of the squeezed light 102. Put another way, the insertion loss of the pump light 108 should be relatively high.

FIGS. 5B-5C depicts two exemplary plots of transmission (e.g., intensity transmission) in the triply-coupled optical resonator 104. FIG. 5B illustrates a first plot of transmission as a function of optical frequency through a triply-coupled optical resonator 104 associated with FIG. 5A, in accordance with one or more embodiments of the present disclosure. FIG. 5C illustrates a second plot of transmission as a function of optical frequency through a triply-coupled optical resonator 104 associated with FIG. 5A, in accordance with one or more embodiments of the present disclosure. It is contemplated herein that a triply-coupled optical resonator 104 designed to provide the plot depicted in FIG. 5C may provide a greater squeezing ratio for squeezed light 102 than a triply-coupled optical resonator 104 designed to provide the plot in FIG. 5B since the transmission of the frequencies associated with the squeezed light 102 (the center split-resonant frequency here) is higher and the transmission of the frequencies associated with the pump light 108 (e.g., the sideband split-resonant frequencies) is lower.

In some embodiments, the triply-coupled optical resonator 104 includes at least one additional filter 512 to pass the squeezed light 102 at the center split-resonant frequency ω₀ and reject any residual light at the sideband split-resonant frequencies ω₋₁ and ω₁. Further, it may be desirable to provide that this additional filter 512 has a low insertion loss to avoid degradation of the squeezed light 102. An insertion loss of 1 dB may be acceptable in some applications, though the properties of the squeezed light 102 may be degraded. An insertion loss of 0.1 dB or lower may provide negligible degradation of the squeezed light 102 in some applications.

In some embodiments, the system 100 includes a homodyne detector 514, which may be used to characterize the squeezed light 102 and/or generate detection signals (e.g., for optical sensing) using the squeezed light 102. For example, a homodyne detector 514 may include an interferometer 516 to combine the squeezed light 102 with signal light 518 having the same wavelength as the squeezed light 102 and may further include photodiodes 520 on both output channels of the interferometer 516. The interferometer 516 may have any suitable design including, but not limited to, a Michelson or a Mach-Zender design.

The system 100 may further include a phase shifter 522 in a path of the signal light 518 to modify a phase of the signal light 518 and thus the propagation of light through the homodyne detector 514. It is contemplated herein that the homodyne detector 514 may provide sensitive detection below a shot noise limit associated with the signal light 518. For example, the system 100 may be utilized as a sensor by modulating the phase of the signal light 518 with sensing data and detecting this phase modulation with the homodyne detector 514. Although not shown, the system 100 may further include a phase shifter in a path of the squeezed light 102 to modify a phase of the squeezed light 102 prior to the homodyne detector 514.

The signal light 518 incident on the homodyne detector 514 may be generated in various ways. For example, in FIG. 5A, the signal light 518 is split directly from the light 502 from the laser source 106. As another example, FIG. 5D illustrates a second simplified schematic of a system 100 providing squeezed light 102 at a center split-resonant frequency ω₀ of a triplet of split-resonant frequencies supported by a triply-coupled optical resonator 104, in accordance with one or more embodiments of the present disclosure. In FIG. 5D, the signal light 518 is generated from an output of a filter 510 between the optical modulator 504 and the triply-coupled optical resonator 104.

Referring now to FIGS. 6A-6E, in some embodiments, the system 100 includes circuitry to lock the frequency of the laser source 106 and/or the pump light 108 with split-frequency resonances of the triply-coupled optical resonator 104. In this way, drifts of the triply-coupled optical resonator 104 and/or the laser source 106 may be compensated for and/or corrected using control techniques.

FIG. 6A illustrates a simplified schematic of a system 100 providing squeezed light 102 at a center split-resonant frequency ω₀ of a triplet of split-resonant frequencies supported by a triply-coupled optical resonator 104 and further providing control circuitry 602 to lock the pump light 108 and the triply-coupled optical resonator 104, in accordance with one or more embodiments of the present disclosure. FIG. 6A is substantially similar to FIG. 5D, but includes additional components for locking the pump light 108 and the triply-coupled optical resonator 104.

The control circuitry 602 may include any combination of components suitable for locking the pump light 108 and the triply-coupled optical resonator 104. For example, the control circuitry 602 may include components to extract data associated with one or more optical frequencies from light at any point in the system 100 such as, but not limited to, one or more filters, comparators, or multiplexers. The control circuitry 602 may further include one or more controllers (e.g., PID controllers, or the like) to control one or more components in the system 100 such as, but not limited to, triply-coupled optical resonator 104 (e.g., the phase shifters 306 therein), the optical modulator 504, or the laser source 106. As an illustration, FIG. 6A depicts a configuration with an additional filter 604 configured to split light associated with the residual split-resonant frequencies ω₋₁ and ω₁ along different paths and photodiodes 606 configured to capture these residual split-resonant frequencies ω₋₁ and ω₁ as inputs to the control circuitry 602, where the control circuitry 602 generates control signals 608 for the triply-coupled optical resonator 104 (e.g., for phase shifters 306 therein).

In some embodiments, the system 100 introduces additional monitoring frequency peaks to the pump light 108, which may provide additional data for control circuitry 602.

FIG. 6B illustrates a simplified schematic of a system 100 providing squeezed light 102 at a center split-resonant frequency ω₀ of a triplet of split-resonant frequencies supported by a triply-coupled optical resonator 104 and further providing control circuitry 602 to lock the pump light 108 and the triply-coupled optical resonator 104 using monitoring frequency peaks 610, in accordance with one or more embodiments of the present disclosure. FIG. 6B is substantially similar to FIG. 6A, but includes additional components for locking the pump light 108 and the triply-coupled optical resonator 104 based on monitoring frequencies.

In FIG. 6B, the optical modulator 504 is driven by two RF signals, one with the split-resonant frequency spacing Ω between split-resonant frequency peaks of the triply-coupled optical resonator 104, and one with a lower frequency ξ. For example, one non-limiting configuration provides Ω=20 GHz and ξ=1 GHz. As a result, the light 508 from the optical modulator 504 includes additional monitoring frequency peaks 610 surrounding the sideband split-resonant frequencies with frequencies ω₋₁±ξ and ω₁±ξ. These monitoring frequency peaks 610 may then be captured by the control circuitry 602.

FIG. 6C illustrates a simplified schematic of a portion of FIG. 7A with additional detail of the control circuitry 602, in accordance with one or more embodiments of the present disclosure. In particular, FIG. 6C depicts Pound-Driver-Hall (PDH) control circuitry 602. In FIG. 6C, the control circuitry 602 includes multiplexers 612 and filters 614 to generate control signals Y and Z for controlling various components including a PID controller 616 coupled to the triply-coupled optical resonator 104, the laser source 106, and the optical modulator 504 (or the RF driver of the optical modulator 504).

FIG. 6D illustrates a plot of a control signal at the Y position of FIG. 6C, in accordance with one or more embodiments of the present disclosure. FIG. 6E illustrates a plot of a control signal at the Z position of FIG. 6C, in accordance with one or more embodiments of the present disclosure. In this configuration, if all resonances of the triply-coupled optical resonator 104 drift together, Y+Z is non-zero and the PID controller 616 may correct the drift in the resonances (e.g., through control signals applied to the phase shifters 306). If the spacing between the resonances changes (e.g., due to a coupling change), then Y-Z is non-zero and the frequency of the RF driver of the optical modulator 504 may be adjusted to compensate.

Referring generally to FIGS. 6A-6E, it is to be understood that FIGS. 6A-6E and the associated descriptions are merely illustrative and should not be interpreted as limiting the scope of the present disclosure. The system 100 may generally include any components suitable for monitoring, control, or stabilization.

Referring now to FIGS. 7A, FIG. 7A illustrates a simplified schematic of a system 100 providing squeezed light 102 at sideband split-resonant frequencies ω₋₁ and ω₁ of a triplet of split-resonant frequencies supported by a triply-coupled optical resonator 104 and further providing control circuitry 602 to lock the pump light 108 and the triply-coupled optical resonator 104 using monitoring frequency peaks, in accordance with one or more embodiments of the present disclosure. FIG. 7A represents and extension of FIG. 6B to stably generate squeezed light 102 using the technique depicted in panel 206 of FIG. 2.

In FIG. 7A, the triply-coupled optical resonator 104 receives pump light 108 including the central split-resonant frequency ω₀ from the laser source 106 and generates squeezed light 102 with the sideband split-resonant frequencies ω₋₁ and ω₁. A filter 702 then isolates the squeezed light 102, which may be directed to a homodyne detector 514. As described with respect to the additional filter 512 above, the filter 702 may also have low insertion loss to prevent degradation of the squeezed light 102.

Further, it is contemplated that the principles described with respect to Equation (1) apply to FIG. 7A as well, except that in FIG. 7A the frequencies of the pump light 108 and the squeezed light 102 are reversed. In particular, the center split-resonant frequency corresponds to pump light 108 and the sideband split-resonant frequencies correspond to the squeezed light 102. For example, it may be desirable to provide high intensity transmission of the sideband split-resonant frequencies and low intensity transmission of the center split-resonant frequency in the triply-coupled optical resonator 104 of FIG. 7A to provide (or preserve) a desired squeezing ratio.

FIG. 7B illustrates a plot of transmission as a function of optical frequency through a triply-coupled optical resonator 104 associated with FIG. 7A, in accordance with one or more embodiments of the present disclosure. FIG. 7B represents performance characteristics similar to that shown in FIG. 5C, but for the arrangement of the system 100 in FIG. 7A.

The system 100 may further include an electro-optic modulator 704 driven by a frequency of Ω to introduce sidebands having the sideband split-resonant frequencies ω₋₁ and ω₁ to a tapped portion of the light 502 from the laser source 106, which may be provided to the homodyne detector 514 for detection as signal light 518.

FIG. 7A further depicts control circuitry 602 for stabilizing the squeezed light 102. In this configuration, the system 100 includes an additional electro-optic modulator 706 driven by a frequency of ξ to introduce monitoring frequency peaks surrounding the pump light 108 at ω₀+ξ. Residual light with the central split-resonant frequency ω₀ isolated with the filter 702 is then fed to the PDH control circuitry 602 along with a signal associated with the RF driving frequency ξ to provide control signals to the triply-coupled optical resonator 104.

It is to be understood that although FIG. 7A was used to demonstrate the generation of squeezed light 102 associated with the sideband split-resonant frequencies of an triply-coupled optical resonator 104, this is merely illustrative and does not limit the scope of the present disclosure. It is contemplated herein that any of the FIGS. 5A-6C may also be extended to provide squeezed light 102 associated with the sideband split-resonant frequencies of an triply-coupled optical resonator 104.

Referring generally to FIGS. 1A-7B, the various components of the system 100 may be provided as separate, couplable components or integrated (e.g., as a PIC device).

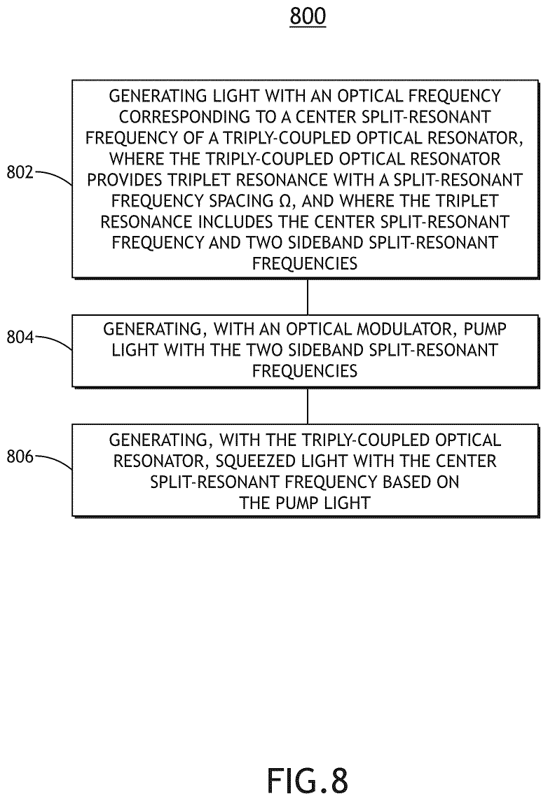

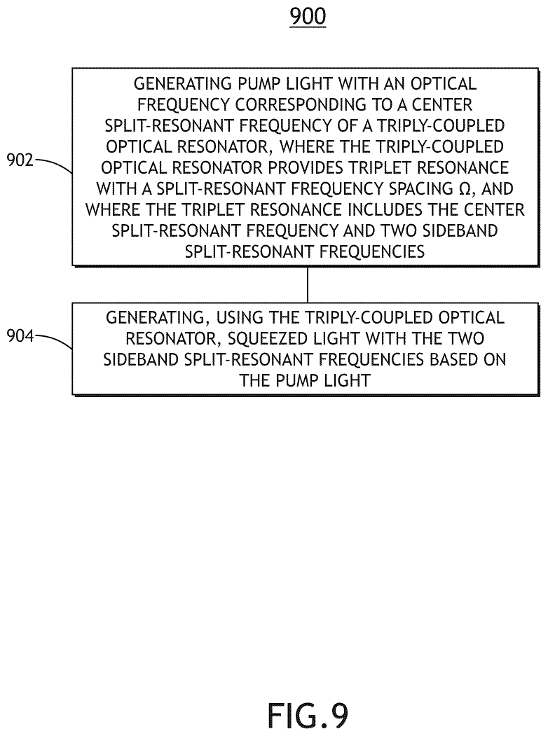

Referring now to FIGS. 8 and 9, methods for generating squeezed light 102 are described, in accordance with one or more embodiments of the present disclosure.

FIG. 8 is a flow diagram illustrating steps performed in a method 800 for generating squeezed light 102 at a center split-resonant frequency of a triply-coupled optical resonator 104, in accordance with one or more embodiments of the present disclosure. The embodiments and enabling technologies described previously herein in the context of the system 100 should be interpreted to extend to the method 800 (e.g., FIGS. 5A-6E) However, the method 800 is not limited to the architecture of the system 100.

The method 800 may include a step 802 of generating light with an optical frequency corresponding to a center split-resonant frequency of a triply-coupled optical resonator 104, where the triply-coupled optical resonator 104 provides triplet resonance with a split-resonant frequency spacing Ω, and where the triplet resonance includes the center split-resonant frequency and two sideband split-resonant frequencies. The method 800 may include a step 804 of generating, with an optical modulator, pump light 108 with the two sideband split-resonant frequencies. The method 800 may include a step 806 of generating, with the triply-coupled optical resonator, squeezed light 102 with the center split-resonant frequency based on the pump light 108.

FIG. 9 is a flow diagram illustrating steps performed in a method 900 for generating squeezed light 102 at a center split-resonant frequency of a triply-coupled optical resonator 104, in accordance with one or more embodiments of the present disclosure. The embodiments and enabling technologies described previously herein in the context of the system 100 should be interpreted to extend to the method 900 (e.g., FIGS. 7A-7B) However, the method 900 is not limited to the architecture of the system 100.

The method 900 may include a step 902 of generating pump light 108 with an optical frequency corresponding to a center split-resonant frequency of a triply-coupled optical resonator 104, where the triply-coupled optical resonator 104 provides triplet resonance with a split-resonant frequency spacing Ω, and where the triplet resonance includes the center split-resonant frequency and two sideband split-resonant frequencies. The method 900 may include a step 904 of generating, using the triply-coupled optical resonator 104, squeezed light 102 with the two sideband split-resonant frequencies based on the pump light 108.

Although the disclosure has been described with reference to the embodiments illustrated in the attached drawing figures, equivalents may be employed and substitutions made herein without departing from the scope of the claims. Components illustrated and described herein are merely examples of a system/device and components that may be used to implement embodiments of the disclosure and may be replaced with other devices and components without departing from the scope of the claims. Furthermore, any dimensions, degrees, and/or numerical ranges provided herein are to be understood as non-limiting examples unless otherwise specified in the claims.

What is claimed:

1. A squeezed light generator comprising:
a triply-coupled optical resonator having a triplet resonance with a split-resonant frequency spacing Ω, wherein the triplet resonance includes a center split-resonant frequency and two sideband split-resonant frequencies;
a laser source configured to generate light with the center split-resonant frequency; and
an optical modulator driven by the split-resonant frequency spacing, wherein the optical modulator is configured to receive the light from the laser source and generate pump light with the two sideband split-resonant frequencies, wherein the triply-coupled optical resonator receives the pump light and generates squeezed light at the center split-resonant frequency.

2. The squeezed light generator of claim 1, further comprising:
a filter to pass the squeezed light at the center split-resonant frequency and reject residual light at the two sideband split-resonant frequencies.

3. The squeezed light generator of claim 2, wherein the filter has an insertion loss equal to or less than 1 dB.

4. The squeezed light generator of claim 1, wherein the optical modulator is configured to at least partially suppress the center split-resonant frequency.

5. The squeezed light generator of claim 1, wherein a squeezing ratio of the squeezed light is provided by S(dB)=−10 log₁₀(1−η+ηV₀), where η is an intensity transmission of the center split-resonant frequency within the triply-coupled optical resonator and V₀ is the squeezing ratio generated in the triply-coupled optical resonator when η is 1.

6. The squeezed light generator of claim 5, wherein the center split-resonant frequency of the triply-coupled optical resonator has the intensity transmission of more than 90% to preserve the squeezing ratio greater than 10 dB.

7. The squeezed light generator of claim 1, further comprising:
one or more filters between the optical modulator and the triply-coupled optical resonator configured to reject the center split-resonant frequency from the pump light.

8. The squeezed light generator of claim 1, wherein the triply-coupled optical resonator includes three triply-coupled traveling-wave resonators.

9. A sensor comprising:
a triply-coupled optical resonator having a triplet resonance with a split-resonant frequency spacing Ω, wherein the triplet resonance includes a center split-resonant frequency and two sideband split-resonant frequencies;
a laser source configured to generate light with the center split-resonant frequency;
an optical modulator driven by the split-resonant frequency spacing, wherein the optical modulator is configured to receive the light from the laser source and generate pump light with the two sideband split-resonant frequencies, wherein the triply-coupled optical resonator receives the pump light and generates squeezed light at the center split-resonant frequency; and
a homodyne detector configured to receive the squeezed light and signal light at the center split-resonant frequency, wherein the homodyne detector generates a detection signal associated with the signal light.

10. The sensor of claim 9, wherein the signal light is generated by tapping a portion of the light from the laser source.

11. The sensor of claim 9, further comprising:
a filter to receive the light from the optical modulator, wherein the filter provides the pump light with the two sideband split-resonant frequencies to the triply-coupled optical resonator and provides light with the center split-resonant frequency as the signal light.

12. The sensor of claim 9, further comprising:
one or more filters between the triply-coupled optical resonator and the homodyne detector to pass the squeezed light at the center split-resonant frequency and reject residual light at the two sideband split-resonant frequencies.

13. The sensor of claim 12, wherein the triply-coupled optical resonator includes one more phase shifters to tune the split-resonant frequency spacing Ω of the triplet resonance.

14. The sensor of claim 13, further comprising:
control circuitry to lock the triply-coupled optical resonator with the pump light.

15. The sensor of claim 14, wherein the optical modulator is further driven by a monitoring frequency ξ to generate monitoring frequency peaks surrounding the two sideband split-resonant frequencies of the pump light, wherein the control circuitry include Pound-Driver-Hall control circuitry.

16. The sensor of claim 9, wherein the triply-coupled optical resonator includes three triply-coupled traveling-wave resonators.

17. The sensor of claim 9, wherein the optical modulator is configured to at least partially suppress the center split-resonant frequency.

18. The sensor of claim 9, further comprising:
one or more filters between the optical modulator and the triply-coupled optical resonator configured to reject the center split-resonant frequency from the pump light.

19. The sensor of claim 9, wherein a squeezing ratio of the squeezed light is provided by S(dB)=−10 log₁₀(1−η+ηV₀), where η is an intensity transmission of the center split-resonant frequency within the triply-coupled optical resonator and V₀ is the squeezing ratio generated in the triply-coupled optical resonator when η is 1.

20. A method comprising:
generating light with an optical frequency corresponding to a center split-resonant frequency of a triply-coupled optical resonator, wherein the triply-coupled optical resonator provides triplet resonance with a split-resonant frequency spacing Ω, wherein the triplet resonance includes the center split-resonant frequency and two sideband split-resonant frequencies;
generating, with an optical modulator, pump light with the two sideband split-resonant frequencies; and
generating, with the triply-coupled optical resonator, squeezed light with the center split-resonant frequency based on the pump light.
